(19) United States
(12) Patent Application Publication
(10) Pub. No.: US 2024/0301991 A1
(43) Pub. Date: Sep. 12, 2024

(54) BRACKET

(71) Applicant: SHENZHEN NEEWER TECHNOLOGY CO. LTD, Shenzhen (CN)

(72) Inventors: Jun WANG, Shenzhen (CN); Yan KE, Shenzhen (CN)

(73) Assignee: SHENZHEN NEEWER TECHNOLOGY CO. LTD, Shenzhen (CN)

(21) Appl. No.: 18/187,844

(22) Filed: Mar. 22, 2023

(30) Foreign Application Priority Data
Mar. 7, 2023 (CN) 202320523468.3

(51) Int. Cl. F16M 11/28; F16M 11/20

(52) U.S. Cl. CPC F16M 11/28; F16M 11/2021; F16M 2200/024; F16M 2200/025; F16M 2200/08

(57) ABSTRACT

Disclosed is a bracket, including: a vertical rod; and at least three supporting members. The at least three supporting member are installed at a lower end of the vertical rod, one end of each supporting member is connected to the vertical rod, another end of each supporting member is abutted against a supporting surface. The at least one supporting member is slidably arranged on the vertical rod along an axial direction of the vertical rod, and at least one supporting member is rotatable along an outer circumference of the vertical rod.

### CROSS-REFERENCE TO RELATED APPLICATIONS

This application claims priority to Chinese Patent Application No. 202320523468.3, filed on Mar. 7, 2023, the content of which is incorporated herein by reference in its entirety.

### TECHNICAL FIELD

The present disclosure relates to the technical field of photographic equipment, and in particular to a bracket.

### BACKGROUND

The tripod is an indispensable tool in the process of photography, especially for outdoor photography. Fixing the camera on the clamping end of the tripod so that the camera can be stabilized and the shooting effect will not be affected by the shaking of the camera body during shooting. When shooting or time-lapse photographing with a telephoto lens or an ultra-telephoto lens in landscape photography, the picture transition can be more stable and the visual clarity can be ensured.

The tripod is structurally divided into the multi-section rod type and the folding type, which is easy to carry after being retracted and folded. When in use, the opened foot is placed on ground or on the object, and the camera can be fixed on it. In order to adapt to different shooting heights and environments, the bracket in the prior art is usually adjustable in height. CN214789982U discloses a photographic tripod, a vertical rod is arranged on the supporting structure, and the supporting structure is fixed to different positions of the vertical rod to adjust the height of the camera at the upper end of the vertical rod. At the same time, the lower end of the supporting structure is fixedly provided with the foot. The body of the foot is a multi-section telescopic rod, which facilitates the adjustment when the ground is potholed.

However, when the bracket is placed on the uneven ground such as the field, since the relative positions of the three feet are fixed, in order to meet the stability and angle requirements of the camera when framing the view, it is necessary to repeatedly test and comprehensively choose the ground where the three feet are located. The length of the feet can be adjusted separately, the stability of the overall structure will be affected by the adjustment of each foot, and the adjustment is complicated and inconvenient.

### SUMMARY

The main objective of the present disclosure is to provide a bracket, aiming to solve a technical problem that when the bracket in the prior art is used, the installation position of the bracket needs to be repeatedly chosen and determined, while changes in each foot will influence the overall structure, the process of which is complicated and the adjustment is inconvenient.

To solve the above problem, the present disclosure provides a bracket, including: a vertical rod; and at least three supporting members.
the at least three supporting member are installed at a lower end of the vertical rod, one end of each supporting member is connected to the vertical rod, another end of each supporting member is abutted against a supporting surface;
the at least one supporting member is slidably arranged on the vertical rod along an axial direction of the vertical rod, and at least one supporting member is rotatable along an outer circumference of the vertical rod.

In an embodiment, the supporting member is slidably arranged on the vertical rod along the axial direction of the vertical rod, and is rotatably arranged on the outer circumference of the vertical rod.

In an embodiment, the supporting members are coaxially sleeved in sequence along the axial direction of the vertical rod.

In an embodiment, each supporting member includes a foot and a first locking structure;
one end of the foot is fixed to the first locking structure, another end of the foot is abutted against the supporting surface; and
the first locking structure is slidably sleeved on the vertical rod, and the first locking structure, driven by an external force, is configured to abut against or loosen from the vertical rod to lock or unlock the supporting member.

In an embodiment, the first locking member includes: a connecting member for connecting the vertical rod and the foot, the connecting member is provided with a communication hole along the axial direction of the vertical rod and a threaded hole along a radial direction of the vertical rod, the threaded hole is in communication with the communication hole, the vertical rod is slidably passing through and defined in the communication hole; and a locking member detachably arranged in the threaded hole, the locking member includes a knob and a stud, the stud is passing through and defined in the threaded hole, and the stud of the locking member, driven by an external force, is configured to abut against or loosen from the vertical rod to lock or unlock the supporting member.

In an embodiment, a vertical distance from a foothold point of the foot of the supporting member to an axis of the vertical rod increases gradually.

In an embodiment, the vertical rod includes at least two sections of telescopic rods, and two adjacent sections of the telescopic rods are slidably sleeved.

In an embodiment, the vertical rod further includes a second locking structure arranged between the two adjacent telescopic rods; and
the second locking structure, driven by an external force, is configured to abut against or loosen from an outer circumference of the telescopic rod with a smaller diameter to confine a relative sliding of the two adjacent telescopic rods.

In an embodiment, the vertical rod includes a first telescopic rod and a second telescopic rod, and a diameter of the first telescopic rod is smaller than a diameter of the second telescopic rod; and
the bracket further includes an elastic member installed between the first telescopic rod and the second telescopic rod, and the elastic member is provided with an elastic force configured to buffer an impulse of the first telescopic rod when moving to a plug position under a gravity.

In an embodiment, one end of the elastic member is installed on an end of the first telescopic rod close to the second telescopic rod, and another end of the elastic member is freely arranged to abut against a plug of the second telescopic rod.

In an embodiment, one end of the elastic member is installed on an end of the second telescopic rod away from the first telescopic rod, and another end of the elastic member is freely arranged to abut against the first telescopic rod.

In an embodiment, the bracket further includes: an installation assembly, including:
an installation rod movably arranged on an end of the vertical rod away from the supporting member, two ends of the installation rod are provided with an installation portion for installing working equipment; and
a third locking structure for connecting the installation rod and the vertical rod, the third locking structure includes a first connecting portion and a second connecting portion, the first connecting portion is fixed to an upper end of the vertical rod, the second connecting portion is rotatably connected to the first connecting portion, and the installation rod is slidably arranged on the second connecting portion.

The technical effects are as follows:

1. The bracket provided by the present disclosure includes a vertical rod and at least three supporting members. At least one supporting member can slide along the axial direction of the vertical rod for height adjustment, and at least another supporting member can rotate along the outer circumference of the vertical rod for angle adjustment, which is flexible and convenient to adjust and can be applied to different environments. At the same time, when the working equipment is installed on the upper end of the vertical rod, the lower supporting member can flexibly adjust the height, the angle, and can cooperatively adjust the center of gravity of the bracket to enhance the stability.

2. The supporting member includes a foot and a first locking structure. The first locking structure is sleeved on the vertical rod through a connecting member, and the foot is connected to the vertical rod. At the same time, the first locking structure is locked by the locking member composed of a knob and a stud, the structure is simple, the operation is convenient, and the material can be easily replaced.

3. The span of each supporting member is gradually changed along the axial direction of the vertical rod, that is, the distance from the foothold point of each supporting member to the axis of the vertical rod is gradually reduced from top to bottom, so as to avoid the interfere between each foot when adjusting the angle and enhance the convenience of the adjustment.

4. The vertical rod is a three-section telescopic rod, the adjacent two telescopic rods can be slidingly sleeved, and a second locking structure is provided. The telescopic structure is convenient for adjusting the height of the bracket, after being retracted, it saves the space and is convenient to carry.

5. An elastic member, for example, a spring is provided between two adjacent telescopic rods as a buffer to prevent the collision between the telescopic rods, which is direct, hard and rigid, and to avoid noise or damage to the second telescopic rod resulting from excessive impact force.

6. The installation assembly facilitates the flexible adjustment of the working equipment, effectively enhances the applicability of working equipment, and improves the working efficiency.

### BRIEF DESCRIPTION OF THE DRAWINGS

In order to illustrate the technical solutions in the embodiments of the present disclosure or in the related art more clearly, the following briefly introduces the accompanying drawings required for the description of the embodiments or the prior art. Obviously, the drawings in the following description are only part of embodiments of the present disclosure. For those skilled in the art, other drawings can also be obtained according to the structures shown in these drawings without any creative effort.

FIG. 1 is a structural schematic view of a bracket according to an embodiment of the present disclosure.

FIG. 2 is a structural schematic view of the bracket according to an embodiment of the present disclosure.

FIG. 3 is a schematic structural view of a supporting member according to an embodiment of the present disclosure.

FIG. 4 is an enlarged view of a third locking structure at portion A in FIG. 2.

FIG. 5 is a schematic view of a foot span of a supporting member according to an embodiment of the present disclosure.

FIG. 6 is a schematic structural view of a connection between the installation rod and the vertical rod according to an embodiment of the present disclosure.

FIG. 7 is an enlarged schematic view at portion D in FIG. 6.

### DETAILED DESCRIPTION OF THE EMBODIMENTS

The technical solutions of the present disclosure will be clearly and completely described below with the accompanying drawings. Apparently, the described embodiments are some of the embodiments of the present disclosure, but not all of them. Based on the embodiments in the present disclosure, all other embodiments obtained by those skilled in the art without making creative efforts belong to the scope of the present disclosure.

In the description of the present disclosure, it should be noted that the terms “center”, “upper”, “lower”, “left”, “right”, “vertical”, “horizontal”, “inner”, “outer” etc. indicate the orientation or positional relationship based on the drawings, and is only for the convenience of describing the present disclosure and simplifying the description, rather than indicating or implying that the referred device or element must have a specific orientation, or in a specific orientation, construction and operation, therefore should not be construed as limiting the disclosure.

In addition, the terms “first”, “second”, and “third” are used for descriptive purposes only, and should not be construed as indicating or implying relative importance.

In the description of the present disclosure, it should be noted that unless otherwise specified and limited, the terms “installation”, “connecting” and “connection” should be understood in a broad sense, for example, it can be a fixed connection, a detachable connection, integrally connected, mechanically connected, electrically connected, directly connected or indirectly connected through an intermediary, and it can be the internal communication of two components. Those skilled in the art can understand the specific meanings of the above terms in the present disclosure according to specific situations.

In addition, the technical features in different embodiments of the present disclosure described below can be combined as long as they do not constitute a conflict with each other.

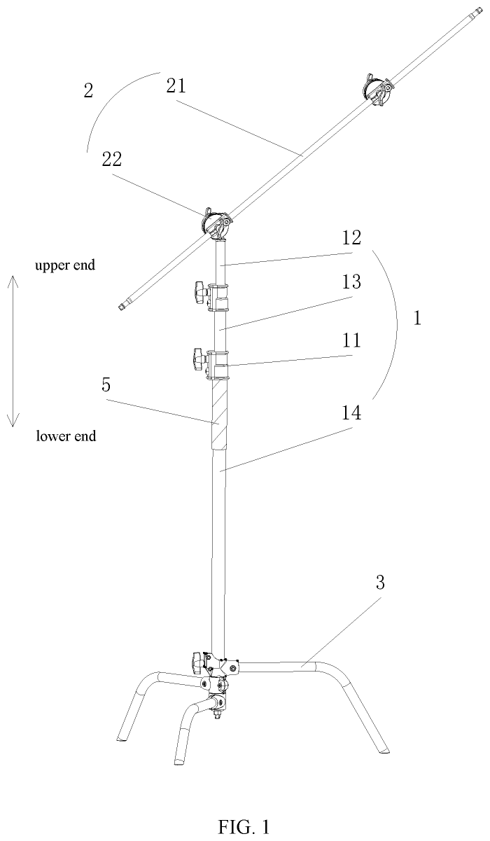

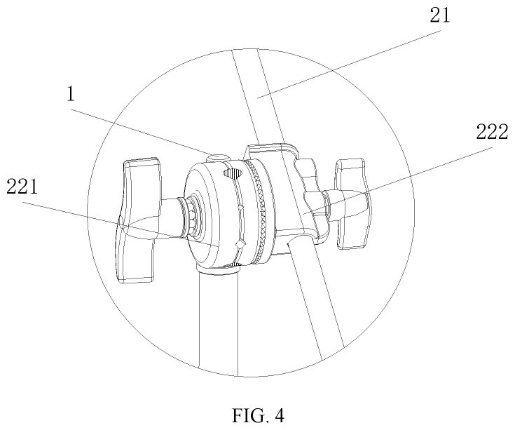

Referring to FIG. 1 to FIG. 7, this embodiment provides a bracket, including: a vertical rod 1 and three supporting members 3 installed at a lower end of the vertical rod 1, one end of each supporting member 3 is connected to the vertical rod 1, and another end of each supporting member 3 is abutted against a supporting surface. One supporting member 3 is slidably arranged on the vertical rod 1 along an axial direction of the vertical rod 1, and is also rotatably arranged along an outer circumference of the vertical rod 1.

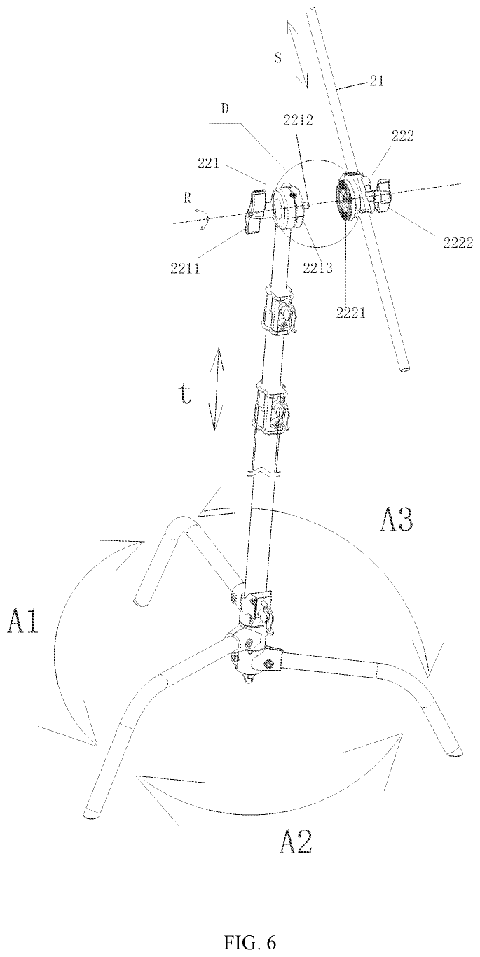

It should be noted that when the vertical rod 1 is in a substantially vertical state, the lower end is a lower part of the vertical rod 1 in the vertical state. Referring to an arrow in FIG. 1, an upper end of the vertical rod 1 is opposite to the lower end. The lower end of the vertical rod 1 is provided with the three supporting members 3, one end of an uppermost supporting member 3 is sleeved on the vertical rod 1, referring to FIG. 6, which can not only slide to adjust a height along the axial direction of the vertical rod 1 along a “t” direction, but also can adjust an angle along the outer circumference of the vertical rod 1 along an “A1” and “A2” and “A3” direction, the adjustment is flexible and convenient, another end of the uppermost supporting member 3 is abutted against various supporting surfaces such as a ground, a step surface and a field, and can be applied to different environments. At the same time, a lowermost supporting member 3 can flexibly adjust the height, the angle, and adjust a center of gravity of the bracket in cooperation with an installation assembly 2 at the upper end of the vertical rod 1 and a working equipment, so as to enhance the stability.

In an embodiment, one supporting member 3 can slide along the axial of the vertical rod 1 to adjust the height, and the other supporting member 3 rotates along the circumference of the vertical rod 1 to adjust the angle. In an embodiment, each supporting member 3 can not only slides along the vertical rod 1 to adjust the height, but also can rotate along the outer circumference of the vertical rod 1 to adjust the angle.

In this embodiment, the three supporting members 3 are sequentially sleeved on the vertical rod 1 along the axial direction of the vertical rod 1, which is easy to install and convenient to adjust. The number of supporting members 3 is not limited to 3, and more such as 5 can be selected according to an actual situation of the site and stability requirements.

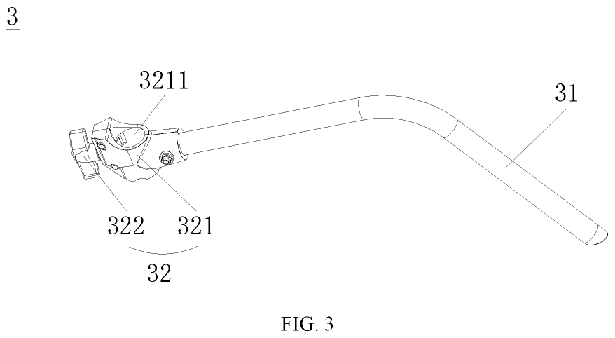

Referring to FIG. 3, in this embodiment, the supporting member 3 includes a foot 31 and a first locking structure 32, one end of the foot 31 is fixed to the first locking structure 32, and another end of the foot 31 is abutted against the supporting surface. The first locking structure 32 is slidably sleeved on the vertical rod 1. Driven by an external force, the first locking structure 32 can abut against the vertical rod 1 to prevent the supporting member 3 from sliding, or the first locking structure 32 can loosen from the vertical rod so that the supporting member 3 can be unlocked to slide.

Referring to FIG. 3, the first locking structure 32 includes a connecting member 321 and a locking member 322. The vertical rod 1 is connected to the foot 31 through a connecting member 321. The connecting member 321 is provided with a connecting hole 3211 formed in the axial direction of the vertical rod 1 and a threaded hole formed along the radial direction of the vertical rod 1, the threaded hole is communicated with the connecting hole 3211, the vertical rod 1 can slide through the connecting hole 3211, which facilitates a sliding and a rotating between the vertical rod 1 and the supporting member 3, the structure is simple, and the relative movement is stable and reliable. The locking member 322 is detachably arranged in the threaded hole, including a knob and a stud, and the stud is passing through and defined in the threaded hole. When the supporting member 3 slides to a certain height along the axial direction of the vertical rod 1, the knob can be turned so that the stud of the first locking member 322 is abutted against the outer circumference of the vertical rod 1 to lock the supporting member 3 and the vertical rod 1. When an adjustment is required, the knob can be turned in an opposite direction so that the stud of the first locking member 322 will be loosened from the outer circumference of the vertical rod 1 to unlock the supporting member 3 and the vertical rod 1. The locking structure is simple, the operation is easy, the material can be easily replaced, and there is no need for motors or complex program controls.

In an embodiment, the first locking structure 32 can be a hoop structure with a flexible gasket, an inner diameter of the hoop structure is slightly smaller than an outer diameter of the vertical rod 1, the supporting member 3 is fixed on the vertical rod 1 through an extrusion force of the flexible gasket, and is locked by a bolt.

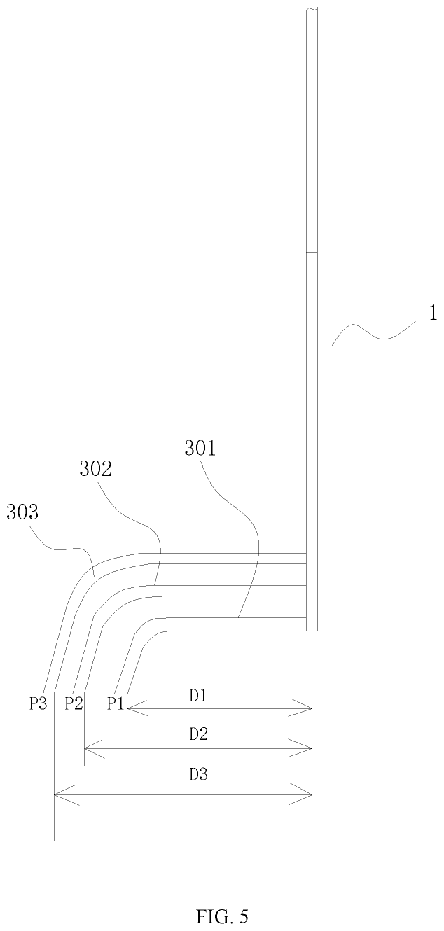

Taking the axis of the vertical rod 1 as a reference, the distance from the end of the axis to the end of the foot 31 of the supporting member 3 as a radius, and the radius of the foot 31 of each supporting member 3 is different. In an embodiment, when the vertical rod 1 is vertically arranged, the distance between a foothold of the foot 31 of each supporting member 3, from top to bottom, and an axis of the vertical rod 1 is gradually reduced. Referring to FIG. 5, the supporting member 3 includes a first supporting member 301, a second supporting member 302 and a third supporting member 303, a vertical distance between the foothold P1 of the first supporting member 301 and the axis of the vertical rod 1 is D1, a vertical distance between the foothold P2 of the second supporting member 302 and the axis of the vertical rod 1 is D2, a vertical distance between the foothold P3 of the first supporting member 303 and the axis of the vertical rod 1 is D3, D3 is greater than D2, and D2 is greater than D1. A curved shape of the first supporting member 301, the second supporting member 302 and the third supporting member 303 are the same, which can avoid a mutual interference of the feet 31 when adjusting the angle, and enhance the convenience of adjustment.

In an embodiment, each foot 31 can be provided with a same span, which is convenient for material extraction and manufacture.

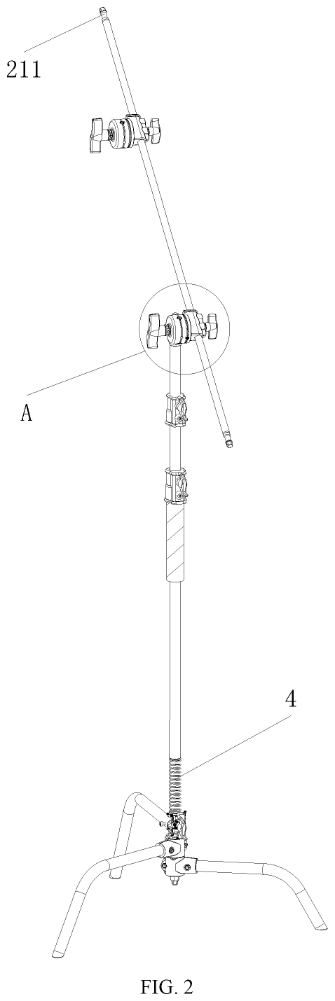

Referring to FIG. 1 and FIG. 2, the vertical rod 1 in this embodiment is a three-section telescopic rod, and the two adjacent telescopic rods are slidably sleeved. The telescopic structure is convenient to adjust the height of the bracket, and saves the space to carry after being retracted.

A second locking structure 11 is also provided between the adjacent two sections of telescopic rods, and is sleeved at an interface of the two adjacent sections of telescopic rods. The locking structure 11 also includes a connecting member 321 and a locking member 322. A knob and a stud of the locking member 322 are arranged on a side of the connecting member 321 near the telescopic rod with a smaller diameter, so that the locking member 322, driven by an external force, is abutted against or loosens from the outer circumference of the telescopic rod with the smaller diameter, so as to confine the relative sliding of the two adjacent telescopic rods, and the relative sliding and fixing between the telescopic rods realize the adjustment and determination of the height of the bracket.

In an embodiment, the vertical rod 1 includes a first telescopic rod 12, a second telescopic rod 13 and a third telescopic rod 14 which are sleeved in sequence along the axial direction of the vertical rod 1. A diameter of the first telescopic rod 12, the second telescopic rod 13 and the third telescopic rod 14 gradually increases or a cross section of the first telescopic rod 12, the second telescopic rod 13 and the third telescopic rod 14 gradually increases, that is, the first telescopic rod 12 can be telescopic in the second telescopic rod 13, and the second telescopic rod 13 can be telescopic in the third telescopic rod 14. An elastic member 4 is installed between the first telescopic rod 12 and the second telescopic rod 13, and another elastic member 4 is installed between the second telescopic rod 13 and the third telescopic rod 14. The elastic members 4 are installed between two adjacent rods to prevent the telescopic rod from colliding when retracting. Referring to FIG. 2, in this embodiment, the bracket is also provided with the elastic member 4, such as a spring respectively installed on an outer lower end of the telescopic rod 12 and the second telescopic rod 13. One end of the elastic member 4 is fixed on an end of the first telescopic rod 12 sleeved into the second telescopic rod 13, another end of the elastic member 4 is a free end. The first telescopic rod 12 is configured to abut against a plug of the second telescopic rod 13 when retracted to the bottom end of the second telescopic rod 13. The plug is a blocking material or a sealing cover arranged at the end of the second telescopic rod 13 and the third telescopic rod 14 to seal a through hole, the elastic member 4 is provided with an elastic force which buffers an impulse of the first telescopic rod 12 when moving to a plug side under a gravity.

When the first telescopic rod 12 is sleeved in the second telescopic rod 13, a spring is provided at the bottom of the first telescopic rod 12, so that the spring will separate every two telescopic rods to prevent a direct, hard and rigid collision between the two telescopic rods when the telescopic rod is retracted. When the first telescopic rod 12 is in an elongated state relative to the second telescopic rod 13, the first telescopic rod 12 is locked by the second locking structure 11 to prevent the first telescopic rod 12 from retracting into the second telescopic rod 13 under a gravity. When the fixing member is loosened, the first telescopic rod 12 will fall back into the second telescopic rod 13 under the gravity. Without the buffer provided by the spring between the bottom of the first telescopic rod 12 and the bottom of the second telescopic rod 13, the bottom of the second telescopic rod 13 will be easily impacted by the first telescopic rod 12, and an excessive impact will cause a noise or a damage to the second telescopic rod 13. The same principle applies on the second telescopic rod 13 and the third telescopic rod 14.

In an embodiment, the elastic member 4 can be fixed at an inner lower end of the second telescopic rod 13 and the third telescopic rod 14, and can also play a buffering role when the first telescopic rod 12 and the second telescopic rod 13 fall down.

Referring to FIG. 1 and FIG. 2, an anti-skid portion 5 is provided on the outside of the third telescopic rod 14, which is convenient for carrying and adjusting when holding the bracket.

Referring to FIG. 1, FIG. 2, FIG. 5, and FIG. 6, the bracket is also provided with an installation assembly 2, including an installation rod 21 and a third locking structure 22, the installation rod 21 is movably arranged on the upper end of the vertical rod 1, two ends of the installation rod 21 are provided with an installation portion 211 for installing working equipment. The installation portion 211 can be a slot or a threaded interface for fixing working equipment such as shooting equipment or lighting lamps. The third locking structure 22 can be provided with a plurality, and is slidably installed on the installation rod for fixing the installation rod and other parts. Referring to FIG. 6, in a embodiment, in order to connect the installation rod 21 to the vertical rod 1, the third locking structure 22 includes a first connecting portion 221 and a second connecting portion 222, the first connecting portion 221 is fixedly mounted on the upper end of the vertical rod 1, the second connecting portion 222 is rotatably connected to the first connecting portion 221, and the installation rod 21 is slidable installed on the second connecting portion 222.

When the second connecting portion 222 is rotated to a preset angle position relative to the first connecting portion 221, the first positioning member will position and lock the second connecting portion 222 on the first connecting portion 221. After sliding on the connecting portion 222 to a preset position, the second positioning member fixes the installation rod 21 on the second connecting portion 222. Specifically, the relative angle between the installation rod 21 and the vertical rod 1 can be adjusted along the R direction, and at the same time, the relative position between the installation rod 21 and the second connecting portion 222 can also be adjusted along the S direction, therefore, When the working equipment such as a photographing equipment or a lighting lamp are fixed on the installation rod 21, a position and a direction of which can be adjusted flexibly, which enhances the applicability of the working equipment and improves the working efficiency.

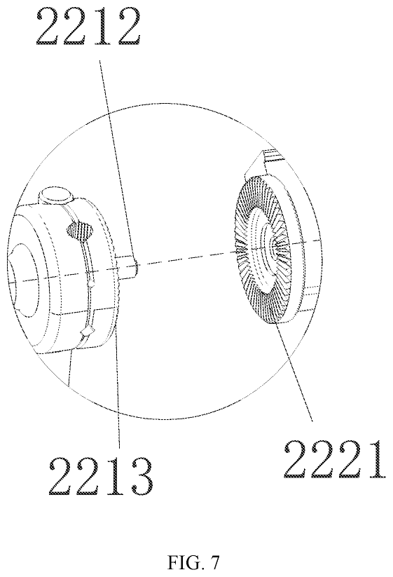

In order to adjust the angle of the second connecting portion 222 relative to the first connecting portion 221, referring to FIG. 6 and FIG. 7, in an embodiment, a first gear annulus 2213 is arranged at one side of the first connecting portion 221. The center of the first gear annulus 2213 is provided with a first threaded through hole. Correspondingly, a second gear annulus 2221 mated with the first gear annulus 2213 is provided on one side of the second connecting portion 222, and the center of the second gear annulus 2221 is provided with a second threaded through hole. The first fixing member includes a first handle 2211 and a first bolt 2212 connected to the end of the first handle 2211. When it needs to be connected and fixed, the first gear annulus 2213 of the first connecting portion 221 is concave-convex matched with the second gear annulus 2221 of the second connecting portion 222. The first handle 2211 can be twisted, the first bolt 2212 is sequentially screwed into the first threaded hole and the second threaded hole, the first gear annulus 2213 is concave-convex fitted with the second gear annulus 2221, a relative position of which is fixed, so that a relative angle between the installation rod 21 and the vertical rod 1 is fixed. When the relative angle between the installation rod 21 and the vertical rod 1 needs to be adjusted, the first handle 2211 is reversely turned, the first bolt 2212 is unscrewed out of the second connecting portion 222, so that the concave-convex fitting of the first gear annulus 2213 and the second gear annulus 2221 is loosened. The angle of the second connecting portion 222 relative to the vertical rod 1 can be adjusted along a R direction, then the second gear annulus 2221 is concave-convex refitted with the first gear annulus 2213, then the first handle 2211 is re-rotated to screw the first bolt 2212 into the second connecting portion 222, finally the relative angle between the installation rod 21 and the vertical rod 1 at the second connecting portion 222 is fixed. In order to realize a sliding and locking function of the installation rod 21 relative to the second connecting portion 222, referring to FIG. 6, in an embodiment, the second connecting portion 222 further includes a through hole and a third threaded hole communicated with the through hole, and the axis of the through hole is perpendicular to the axis of the third threaded hole. The second positioning member includes a second handle 2222 and a second bolt fixed on a side of the second handle 2222. The installation rod 21 can be slidably inserted into the through hole, the second handle 2222 is rotated to screw the second bolt into the third threaded hole until the end of the second bolt is abutted against the installation rod 21, thereby fixing the installation rod 21 to prevent it from sliding along a S direction in the through hole.

When the relative position between the installation rod 21 and the second connecting portion 222 needs to be adjusted along the S direction, the second handle 2222 is reversely loosened, so that the second bolt is unscrewed and the end of the second bolt is separated from the installation rod 21, then the position of the installation rod 21 can be adjusted along the S direction. After the adjustment, the second handle 2222 can be re-tightened to screw the second bolt into the third threaded hole until the end of the second bolt is abutted against the installation rod 21 to fix the installation rod 21.

Apparently, the above-mentioned embodiments are only examples for clearly illustrating, rather than a limitation to the present disclosure. For those skilled in the art, based on the above description, other changes or changes in different forms can also be made. It is not necessary and impossible to exhaustively list all the implementation manners here. The obvious changes or variations derived therefrom are still within the scope the present disclosure.

What is claimed is:

1. A bracket, comprising:
a vertical rod; and
at least three supporting members, the at least three supporting member being installed at a lower end of the vertical rod, one end of each supporting member being connected to the vertical rod, another end of each supporting member being abutted against a supporting surface;
wherein at least one supporting member is slidably arranged on the vertical rod along an axial direction of the vertical rod, and at least one supporting member is rotatable along an outer circumference of the vertical rod.

2. The bracket of claim 1, wherein the supporting member is slidably arranged on the vertical rod along the axial direction of the vertical rod, and is rotatably arranged on the outer circumference of the vertical rod.

3. The bracket of claim 2, wherein the supporting members are coaxially sleeved in sequence along the axial direction of the vertical rod.

4. The bracket of claim 3, wherein:
each supporting member comprises a foot and a first locking structure;
one end of the foot is fixed to the first locking structure, another end of the foot is abutted against the supporting surface; and
the first locking structure is slidably sleeved on the vertical rod, and the first locking structure, driven by an external force, is configured to abut against or loosen from the vertical rod to lock or unlock the supporting member.

5. The bracket of claim 4, wherein the first locking member comprises:
a connecting member for connecting the vertical rod and the foot, the connecting member being provided with a communication hole along the axial direction of the vertical rod and a threaded hole along a radial direction of the vertical rod, the threaded hole being in communication with the communication hole, the vertical rod being slidably passing through and defined in the communication hole; and
a locking member detachably arranged in the threaded hole,
wherein the locking member comprises a knob and a stud, the stud is passing through and defined in the threaded hole, and the stud of the locking member, driven by an external force, is configured to abut against or loosen from the vertical rod to lock or unlock the supporting member.

6. The bracket of claim 5, wherein a vertical distance from a foothold point of the foot of the supporting member to an axis of the vertical rod increases gradually.

7. The bracket of claim 6, wherein the vertical rod comprises at least two sections of telescopic rods, and two adjacent sections of the telescopic rods are slidably sleeved.

8. The bracket of claim 7, wherein:
the vertical rod further comprises a second locking structure arranged between the two adjacent telescopic rods; and
the second locking structure, driven by an external force, is configured to abut against or loosen from an outer circumference of the telescopic rod with a smaller diameter to confine a relative sliding of the two adjacent sections of the telescopic rods.

9. The bracket of claim 8, wherein:
the vertical rod comprises a first telescopic rod and a second telescopic rod, and a diameter of the first telescopic rod is smaller than a diameter of the second telescopic rod; and
the bracket further comprises an elastic member installed between the first telescopic rod and the second telescopic rod, and the elastic member is provided with an elastic force configured to buffer an impulse of the first telescopic rod when moving to a plug position under a gravity.

10. The bracket of claim 9, wherein one end of the elastic member is installed on an end of the first telescopic rod close to the second telescopic rod, and another end of the elastic member is freely arranged to abut against a plug of the second telescopic rod.

11. The bracket of claim 9, wherein one end of the elastic member is installed on an end of the second telescopic rod away from the first telescopic rod, and another end of the elastic member is freely arranged to abut against the first telescopic rod.

12. The bracket of claim 1, further comprising:
an installation assembly, comprising:
an installation rod movably arranged on an end of the vertical rod away from the supporting member, two ends of the installation rod being provided with an installation portion for installing working equipment; and
a third locking structure for connecting the installation rod and the vertical rod,
wherein the third locking structure comprises a first connecting portion and a second connecting portion, the first connecting portion is fixed to an upper end of the vertical rod, the second connecting portion is rotatably connected to the first connecting portion, and the installation rod is slidably arranged on the second connecting portion.
